(19) United States
(12) Patent Application Publication
(10) Pub. No.: US 2006/0132434 A1
(43) Pub. Date: Jun. 22, 2006

(54) Method and apparatus for controlling a display

(76) Inventor: Trevor J. Kern, Edmonton (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/293,020

(22) Filed: Dec. 2, 2005

Related U.S. Application Data
(60) Provisional application No. 60/633,148, filed on Dec. 3, 2004.

(51) Int. Cl. G09G 5/00

(52) U.S. Cl. 345/156

(57) ABSTRACT

A method and apparatus for controlling a display in which the display is provided with an embedded switch with a sensor interface. The switch is adapted to switch the display between an active state and a dormant state based upon sensor input. The display is switched to an active state upon the embedded switch receiving input from the sensor of the presence of a potential viewer. The display is switched to a dormant state in the absence of input from the sensor.

This application claims the benefit of U.S. Provisional Application Ser. No. 60/633,148 filed Dec. 3, 2005.

### FIELD OF THE INVENTION

The present invention relates to method and apparatus for controlling a display.

### BACKGROUND OF THE INVENTION

Display devices of that commonly used to produce images on a screen are subject to limited life spans that are determined by the type of technology of the display and the total amount of time the display is operated.

Liquid crystal (LCD) and other non-emissive types of displays such as front or rear projection monitors use lamps as their light source. These lamps have a limited life span, no matter what present light-source technology is used (i.e. fluorescent lamps, light-emitting diodes). Other emissive-type of displays (i.e. Plasma, electroluminescent, CRT) also have limited life that is determined mainly by the brightness setting of the display and the total amount of time the display is operated.

Non-emissive displays used in outdoor applications in particular require high-output light sources for the images to be seen under sunlight conditions. As such, the light source is used at full brightness, greatly affecting the service life of the display. Other types of displays (i.e. emissive type), if operated at full brightness for extended periods of time will also exhibit accelerated aging and ultimate failure.

### SUMMARY OF THE INVENTION

According to the present invention there is provided a method and apparatus for controlling a display in which the display is provided with an embedded switch with an internal sensor or a simple external sensor interface. The switch is adapted to switch the display between an active state and a dormant state based upon sensor input. The display is quickly switched to an active state upon the embedded switch receiving input from the sensor of the presence of a potential viewer. The display is eventually switched to a dormant state in the absence of input from the sensor.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view illustrating a method for controlling a display in accordance with the teachings of the present invention, the potential viewer being in a vehicle.

FIG. 2 is a side elevation view illustrating a method for controlling a display in accordance with the teachings of the present invention, the potential viewer being a pedestrian and the sensor being built into the display.

FIG. 3 is a side elevation view of illustrating a method for controlling a display in accordance with the teachings of the present invention, the potential viewer being a pedestrian and the sensor being external to the display.

FIG. 4 is a schematic representation of an apparatus for controlling a display as illustrated in FIG. 2

### DETAILED DESCRIPTION OF THE PREFERRED EMBODIMENT

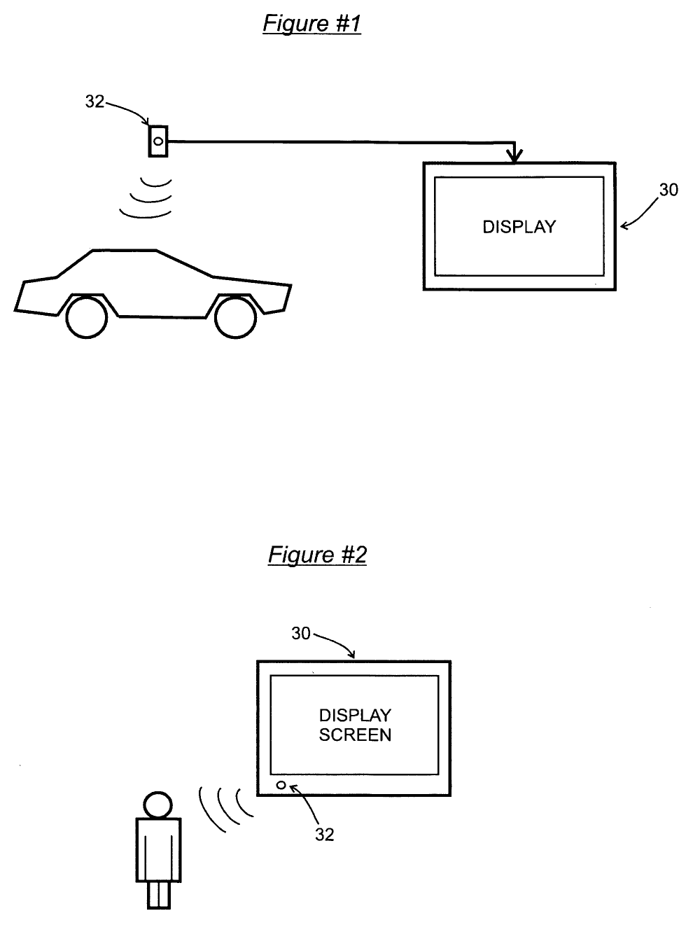

The preferred method will now be described with reference to FIG. 1 through 4.

Referring to FIG. 4, there is illustrated an apparatus for controlling display unit 30 which is constructed in accordance with the teachings of the method. Display unit 30 has a display screen 31 and an embedded switch 33 with a sensor interface. Switch 33 is adapted to switch display screen 31 between an active state and a dormant state based upon sensor input. A sensor 32 is provided which is adapted to detect the presence of a potential viewer. A single sensor has been illustrated, however, it will be appreciated that there could be more than one sensor. Means are provided for coupling sensor 32 to the sensor interface for embedded switch 33. A hardwired connection has been shown. It will be appreciated that it could also be a wireless connection. Display screen 31 is quickly switched to an active state upon embedded switch 33 receiving input from sensor 32 of the presence of a potential viewer. Display screen 31 is eventually switched to a dormant state in the absence of input from sensor 32.

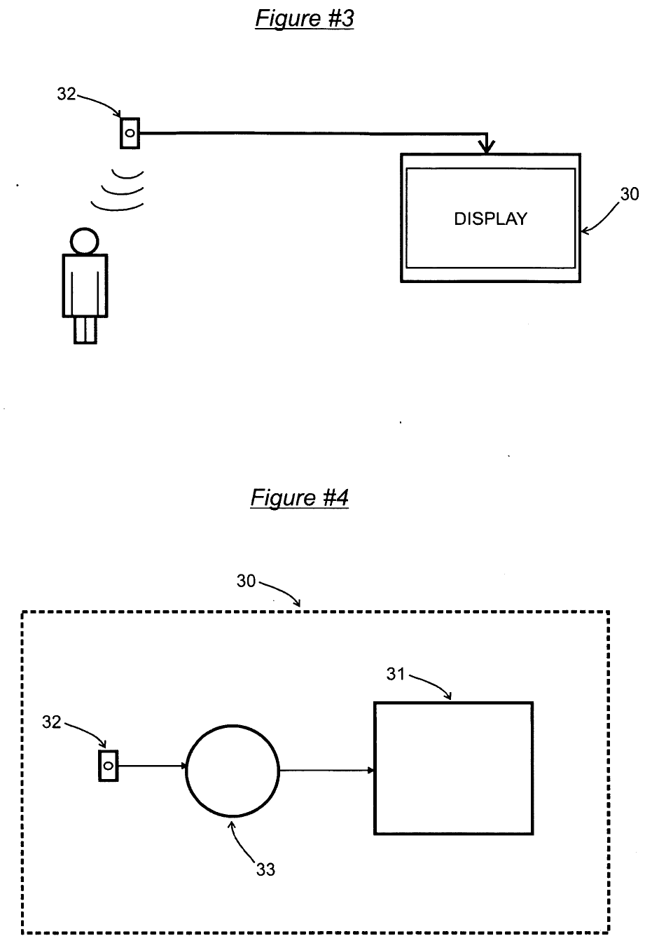

This system was originally developed for use in menu displays for drive through restaurants. FIG. 1 illustrates how the method is put into practise when the potential viewer is in a vehicle. It will be appreciated that the system is equally applicable to sidewalk displays, and FIG. 2 and FIG. 3, illustrate how the method is put into practise when the potential viewer is a pedestrian.

The detection means (sensor 32) can be either remotely located as illustrated in FIG. 3 or integral to the display as illustrated in FIG. 2. With the detection means connected to the display or the light source, the display screen 31 is quickly activated, turned on, or operated by the approach or presence of a potential viewer within a certain limited distance of the display. After turn-on, the display remains in an ‘on’ state for as long as the potential viewer is present, or a pre-determined period of time, or both. To avoid frequent repeated on-off cycling, it is preferred that a timer be employed to provide a minimum sustained operational period of display screen 31, once activated, as deemed appropriate for the specific type of display and/or application.

### ADVANTAGES

Beneficial results may be obtained from quick activation of the display by the detection means by reducing the total amount of time the display is in the ‘on’ state, thereby allowing the display to have a longer life, whilst not reducing the effectiveness of the display in many applications. In addition, service costs and down-time may be reduced.

Even more beneficial results may be obtained if the sensor is integral to the display, as opposed to external sensors, as the entire apparatus is then self-contained, allowing more flexibility in application and less costly installation.

The present invention prevents much of the display's life being wasted by being operated, or turned-on, when there is no viewer is in the vicinity. In addition to extending lamp or display life, there is a significant reduction in power consumption. There is also a reduction in vandalism, as a dormant display is less likely to attract the attention of more distant potential vandals.

A “dormant” state referred to in this application need not be a total power shut off, but is preferred to be a state where the brightness is set at a minimum level, but can be quickly restored to viewable levels.

Computer screens used on desk top computers frequently have a dormant state. The user brings the computer screen out of the dormant state by striking the computer keys or moving the computer mouse. Televisions have remote control sensors for accepting commands. These are all dependant on voluntary actions on the part of the user. The use of sensors in accordance with the teachings of the present invention is a way of quickly bringing the display screen from a dormant mode to an active mode through involuntary actions of potential viewers approaching the display. This display device has the inherent capability to change states from active to dormant depending upon the presence or absence of viewers within the visual realm of the display. It does this working with either external but preferably internal sensors capable of detecting a potential viewer approaching the display on foot or in a vehicle. Where an external sensor is utilized, it is important to note that it does this through an embedded switch within the display that operates from any simple open or closed contact sensor input and specifically without the aid of an intermediate or more complex computer interface between the external sensor and the display device. Prior control and interface means to command displays require coded input signals that are compatible with it's internal software or firmware. Prior motion activated power switches, which can only turn power completely on or off to the display, are not suitable as the power-on time before the display is usable can be considerable, and the potential viewer would have most likely moved on without even having seen the display operate. Moreover, certain lamps used in transmissive displays require warm-up time to achieve full brightness while repetitive power-cycling can also cause premature lamp failure.

Where an external sensor is utilized, by providing a simple sensor interface to control the embedded switch adapted to quickly change the state of the display from dormant to active states solely by the input of an open or closed circuit, the need for intermediate or computer control of the display is eliminated. Now with such a simple input, a variety of commercially available sensors may be used, such as Passive Infrared (PIR) motion sensors, photo-based object sensors or inductive-loop vehicle detectors, without any further apparatus whatsoever.

Where an integral built-in sensor is utilized, by providing an embedded switch that can cause the display to either substantially reduce brightness or cause the brightness to quickly be restored to viewable levels, based on input from the integral sensor, all the advantages presently described are achieved. Now with such an embedded switch, a variety of sensors may be used, such as motion sensors and magnetic anomaly vehicle detectors, without any further apparatus whatsoever.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A method for controlling a display, comprising the steps of:
embedding in the display an embedded switch with a sensor interface, the switch being adapted to switch the display between an active state and a dormant state based upon sensor input;
providing at least one sensor adapted to detect the presence of a potential viewer;
coupling the at least one sensor to the sensor interface for the embedded switch, such that the display is switched to an active state upon the embedded switch receiving input from the at least one sensor and the display is eventually switched to a dormant state in the absence of input from the at least one sensor.

2. The method as defined in claim 1, wherein the display is an electronic commercial display.

3. The method as defined in claim 2, wherein the display is positioned for pedestrian viewing along a pedestrian walkway with the sensor activating the display upon the presence of a pedestrian being detected in close proximity on the pedestrian walkway.

4. The method as defined in claim 2, wherein the display is positioned for viewing along a vehicle drive path with the sensor activating the display upon the presence of a potential viewer in a vehicle being detected in close proximity on the vehicle drive path.

5. An apparatus for controlling a display, comprising:
a display having an embedded switch with a sensor interface, the switch being adapted to switch the display between an active state and a dormant state based upon sensor input;
at least one sensor adapted to detect the presence of a potential viewer;
means for coupling the at least one sensor to the sensor interface for the embedded switch, such that the display is switched to an active state upon the embedded switch receiving input from the at least one sensor and the display is eventually switched to a dormant state in the absence of input from the at least one sensor.

6. The apparatus as defined in claim 5, wherein the sensor is embedded in the display.

7. The apparatus as defined in claim 5, wherein the display is an electronic commercial display.
